(19) United States
(12) Patent Application Publication
(10) Pub. No.: US 2026/0259854 A1
(43) Pub. Date: Sep. 3, 2026

(54) Quantum Operation Processing Method, Apparatus, and System

(71) Applicant: Alibaba (China) Co., Ltd., Hangzhou, Zhejiang (CN)

(72) Inventors: Xing ZHU, Hangzhou, Zhejiang (CN); Liwei QIU, Hangzhou, Zhejiang (CN); Linghang KONG, Hangzhou, Zhejiang (CN)

(21) Appl. No.: 19/162,800

(22) PCT Filed: Feb. 4, 2024
(86) PCT No.: PCT/CN2024/075865

§ 371 Date: Sep. 5, 2025

(30) Foreign Application Priority Data
Mar. 10, 2023 (CN) 202310253326.4

(51) Int. Cl. G06F 15/82; G06N 10/40

(52) U.S. Cl. CPC G06F 15/82; G06N 10/40

(57) ABSTRACT

Disclosed in the present disclosure are a quantum operation processing method, apparatus, and system. The above solution relates to the quantum technical field. The method includes: receiving a control instruction from a processor, where the control instruction is configured to indicate to perform a quantum operation on a plurality of quantum devices; based on the control instruction, acquiring a quantum operation instruction from a storage device externally mounted on the processor; and determining a plurality of target electronic devices corresponding to the quantum operation instruction, where the plurality of target electronic devices are respectively configured to generate, based on the quantum operation instruction, a waveform signal for performing the quantum operation on the corresponding quantum devices.

### TECHNICAL FIELD

The present disclosure relates to the technical field of quanta, and specifically, to a quantum operation processing method, apparatus, and system.

### BACKGROUND

During quantum computing, an electronic device needs to be controlled to generate a required waveform signal according to a specific time sequence, the waveform signal is collected at a set time window, and a quantum device (e.g., a quantum bit) is controlled based on the collected waveform signal. When one quantum device is controlled, the control of the quantum device can be realized by generating the waveform signal using one electronic device. However, when the number of the quantum devices is increased, the number of the electronic devices that need to be controlled is increased accordingly. In the related art, when the number of electronic devices that need to be controlled is increased, a realized control amount is increased accordingly, resulting in increased control complexity.

In view of the above problem, no effective solution has been proposed yet.

### SUMMARY

Embodiments of the present disclosure provide a quantum operation processing method, apparatus, and system, so as to at least solve the technical problem in the related art of increased control complexity caused by a realized control amount increased accordingly when the number of electronic devices that need to be controlled is increased.

An aspect of the embodiments of the present disclosure provides a quantum operation processing method, including: a control instruction from a processor is received, where the control instruction is configured to indicate to perform a quantum operation on a plurality of quantum devices; based on the control instruction, a quantum operation instruction is acquired from a storage device externally mounted on the processor; and a plurality of target electronic devices corresponding to the quantum operation instruction is determined, where the plurality of target electronic devices are respectively configured to generate, based on the quantum operation instruction, a waveform signal for performing the quantum operation on the corresponding quantum devices.

Optionally, before acquiring, based on the control instruction, the plurality of quantum operation instructions from the storage device externally mounted on the processor, the method further includes: different types of the quantum operation instructions are stored in different address partitions in the storage device.

Optionally, the storage device is mounted on a system bus of the processor through a Memory Mapping Input/Output (MMIO) interface.

Optionally, determining the plurality of target electronic devices corresponding to the quantum operation instruction includes: when the quantum operation instruction carries first group information, the quantum operation instruction is broadcast to a plurality of candidate electronic devices, where the first group information is configured to indicate an electronic device targeted by the quantum operation instruction; a matching result between the first group information carried by the quantum operation instruction and second group information for the plurality of candidate electronic devices is acquired; and the plurality of target electronic devices are determined based on the matching results corresponding to the plurality of candidate electronic devices.

Optionally, after determining the plurality of target electronic devices corresponding to the quantum operation instruction, the method further includes: when the quantum operation instruction is a non-waveform operation instruction, a mapping relationship between the non-waveform operation instruction and a waveform operation instruction is acquired; and the non-waveform operation instruction is mapped into the waveform operation instruction based on the mapping relationship, where the waveform operation instruction is configured to generate the waveform signal.

Optionally, converting the non-waveform operation instruction into the waveform operation instruction based on the mapping relationship includes: the mapping relationship is determined as a first relationship when the non-waveform operation instruction includes a first gate operation instruction, where the first relationship is a correspondence relationship between a gate operation instruction and the waveform operation instruction; and the first gate operation instruction is mapped into a first waveform operation instruction based on the first relationship.

Optionally, converting the non-waveform operation instruction into the waveform operation instruction based on the mapping relationship includes: the mapping relationship is determined as a first relationship and a second relationship when the non-waveform operation instruction includes an application operation instruction, where the first relationship is a correspondence relationship between a gate operation instruction and the waveform operation instruction, and the second relationship is a correspondence relationship between the application operation instruction and the gate operation instruction; the application operation instruction is mapped into a second gate operation instruction based on the second relationship; and the second door operation instruction is mapped into a second waveform operation instruction based on the first relationship.

Optionally, the method further includes: the mapping relationship is determined based on at least two memories, where one of the at least two memories is configured to store a time for mapping the corresponding quantum operation, and the other one is configured to store an identifier for mapping the corresponding quantum operation.

Optionally, the method further includes: a relationship update instruction is received; and the mapping relationship is updated in response to the relationship update instruction.

Optionally, the quantum device is a quantum bit, and the quantum bit is a Fluxonium quantum bit.

Another aspect of the embodiments of the present disclosure provides a quantum operation processing apparatus, including: a receiving module, configured to receive a control instruction from a processor, where the control instruction is configured to indicate a quantum operation on a plurality of quantum devices; an acquisition module, configured to acquire, based on the control instruction, a quantum operation instruction from a storage device externally mounted on the processor; and a determination module, configured to determine a plurality of target electronic devices corresponding to the quantum operation instruction, where the plurality of target electronic devices are respectively configured to generate, based on the quantum operation instruction, a waveform signal for performing the quantum operation on the corresponding quantum devices.

Another aspect of the embodiments of the present disclosure provides a quantum operation processing system, including: a main control device and a digital-to-analog converter, where the main control device includes a processor, a storage device, and an actuator; the digital-to-analog converter includes a parser and an electronic device; the processor is configured to generate a control instruction, and the control instruction is configured to indicate a quantum operation on a plurality of quantum devices; the storage device is configured to store a quantum operation instruction; the actuator is configured to acquire, based on the control instruction, a quantum operation instruction from a storage device externally mounted on the processor; the parser is configured to determine the plurality of target electronic devices corresponding to the quantum operation instruction; and the electronic device is configured to generate, based on the quantum operation instruction, a waveform signal for performing the quantum operation on the corresponding quantum devices.

Optionally, the main control device is connected to the digital-to-analog converter through a star connector, so as to transmit the quantum operation instruction acquired by the actuator to the parser.

Optionally, the system further includes an analog-to-digital converter, where the analog-to-digital converter is configured to read a quantum state of a quantum chip to obtain a read result, and transmit the read result to the storage device.

Optionally, the storage device is mounted on a system bus of the processor through an MMIO interface.

Yet another aspect of the present disclosure provides a computer-readable storage medium. The computer-readable storage medium includes a stored program. When the program is operated, a device in which the computer-readable storage medium is located is controlled to perform any one of the above quantum operation processing methods.

Still another aspect of the present disclosure further provides a computer device, including a memory and a processor. The memory stores a computer program. The processor is configured to perform the computer program stored in the memory. When the computer program is operated, the processor is enabled to perform any one of the above quantum operation processing methods.

In the embodiments of the present disclosure, the control instruction from the processor is received, where the control instruction is configured to indicate the quantum operation on the plurality of quantum devices; based on the control instruction, the quantum operation instruction is acquired from the storage device externally mounted on the processor; and the plurality of target electronic devices corresponding to the quantum operation instruction is determined, and the plurality of target electronic devices respectively generate, based on the quantum operation instruction, the waveform signal for performing the quantum operation on the corresponding quantum devices. The control instruction of the processor can perform the quantum operations on the plurality of quantum devices at one time. With respect to the related art, a single quantum operation instruction is required for the quantum operation of one quantum device. For the single control instruction, the plurality of quantum devices can be operated by one control instruction, such that the processing efficiency of the quantum operation is effectively improved, the high efficiency of the instruction is achieved, and the technical problem in the related art of increased control complexity caused by a realized control amount increased accordingly when the number of electronic devices that need to be controlled is increased is solved.

### BRIEF DESCRIPTION OF THE DRAWINGS

The accompanying drawings described herein are used to provide a further understanding of the present disclosure, and constitute a part of the present disclosure. The exemplary embodiments of the present disclosure and the description thereof are used to explain the present disclosure, but do not constitute improper limitations to the present disclosure. In the drawings:

FIG. 1 is a block diagram of a hardware structure of a quantum operation processing system according to embodiments of the present disclosure.

FIG. 2 is a flowchart of a quantum operation processing method according to Embodiment 1 of the present disclosure.

FIG. 3 is a system architecture diagram of a quantum operation processing system according to optional implementations of the present disclosure.

FIG. 4 is a schematic diagram of a connecting structure between a processor and a storage device in a quantum operation instruction processing method according to optional implementations of the present disclosure.

FIG. 5 is a schematic diagram of a mapping relationship between quantum operation instructions according to optional implementations of the present disclosure.

FIG. 6 is a structural block diagram of a quantum operation processing apparatus according to embodiments of the present disclosure.

FIG. 7 is a structural block diagram of a computer terminal according to embodiments of the present disclosure.

### DETAILED DESCRIPTION OF THE EMBODIMENTS

In order to enable those skilled in the art to better understand the solutions of the present disclosure, the technical solutions in the embodiments of the present disclosure will be clearly and completely described below in combination with the drawings in the embodiments of the present disclosure. It is apparent that the described embodiments are only part of the embodiments of the present disclosure, not all the embodiments. Based on the embodiments in the present disclosure, all other embodiments obtained by those of ordinary skill in the art without creative work shall fall within the protection scope of the present disclosure.

It is to be noted that terms “first”, “second” and the like in the description, claims and the above mentioned drawings of the present disclosure are used for distinguishing similar objects rather than describing a specific sequence or a precedence order. It should be understood that the data used in such a way may be exchanged where appropriate, in order that the embodiments of the present disclosure described here can be implemented in an order other than those illustrated or described herein. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

First, some of the nouns or terms or appearing in the course of the description of the embodiments of the present disclosure are applicable to the following explanations.

Quantum computing is a new computing mode that follows the laws of quantum mechanics to regulate a quantum information unit for computing. In contrast to a traditional general-purpose computer, a theoretical model is a universal Turing machine; and a theoretical model of a universal quantum computer is a universal Turing machine that is re-interpreted by the laws of quantum mechanics. From the perspective of a computable problem, a quantum computer can only solve the problem that can be solved by traditional computers. However, in terms of computing efficiency, due to the presence of quantum superposition, certain known quantum algorithms process the problems faster than traditional general-purpose computers.

As a computing and control core of a computer system, the Central Processing Unit (CPU) is a final execution unit for information processing and program running. The CPU is one of the main devices of an electronic computer, is a core component in the computer, and has functions that are mainly to interpret computer instructions and process data in computer software. The CPU is the core component of the computer that is responsible for reading instructions, decoding the instructions, and performing the instructions. The CPU mainly includes two portions, which are a controller and an arithmetic unit, and further includes a high-speed cache memory, as well as data and control buses that connect the above components. The three core components of the electronic computer are the CPU, an internal memory, and an input/output device. The main functions of the CPU are to process instructions, perform operations, control times, and process data. In a computer system structure, the CPU is a core hardware unit that controls and allocates all hardware resources (e.g., memories and input/output units) and performs general operations. The CPU is the computing and control core of the computer. Operations in all software layers in the computer system are ultimately mapped into CPU operations through an instruction set. In the CPU that performs quantum control, different types of control may be implemented by using various cores. For example, some cores are used to control classical instructions, while others are used to control quantum instructions.

An electronic device, also known as a room temperature measurement and control device, refers to a waveform acquisition device, an arbitrary waveform generator, or a microwave source. In the embodiments of the present disclosure, it refers to a device system that generates a corresponding waveform signal based on a waveform operation instruction. The process of generating the waveform signal includes generating a waveform and collecting the required waveform signals from the generated waveform. It is to be noted that, the above electronic device may be a general term of processing modules involved in the process of generating the above waveform signal, or may also be referred to as an electronic system.

A microinstruction refers to a set of microoperations performed by a control signal emitted simultaneously in a microprogram-controlled computer. The microinstruction is formed by gathering information related to the control signal emitted simultaneously. One instruction is divided into a plurality of microinstructions, which are performed in sequence to achieve the function of the instruction. The plurality of microinstructions may constitute a microprogram, and one microprogram corresponds to one machine instruction. The microinstruction is a combination of a set of microcommands that perform a specific operation within a CPU cycle of a machine, which is a statement that describes the microoperation. The microcommand means that a control component sends various control commands to an execution component through a control line. Operation microinstructions are operational statements that describe a controlled circuit, while branch microinstructions are branch statements that describe a control circuit. The function of a machine instruction is implemented by a sequence consisting of the plurality of microinstructions, that is, an operation performed by one machine instruction is completed by being divided into the plurality of microinstructions, and is interpreted and performed by the microinstructions. This microinstruction sequence is generally referred to as a microprogram. A compilation method for the microinstruction is a main factor determining a microinstruction format. Considering factors such as speed and cost, different compilation methods are used during the designing of the computer. Therefore, the formats of the microinstructions are generally divided into two categories: horizontal microinstructions and vertical microinstructions.

sw/lw operations refer to write and read operations of data, and, in the embodiments of the present disclosure, respectively indicates that the CPU stores the data in the data (writing data, corresponding to a write instruction) to a data memory and reads the data (corresponding to a load instruction) from the data memory.

Memory mapping I/O (MMIO) is a portion of the Peripheral Component Interconnect (PCI) specification, and an I/O device is placed in a memory space rather than an I/O space. From the perspective of the CPU, the system device accessed via MMIO behaves just like the memory. In this way, by accessing the frame buffer on a graphics card, a Basic Input Output System (BIOS), and a PCI device may be implemented by using an assembly instruction same as a read/write memory, simplifying the difficulty of program design and reducing the complexity of the interface. I/O serves as a channel for communication between the CPU and a peripheral device, and is primarily divided into two types: Port I/O and MMIO. The former is commonly referred to as an I/O port, and should actually be referred to as an I/O address space.

A Random Access Memory (RAM), also known as a main memory, is an internal memory that directly exchanges the data with the CPU. It may be read and written at any time (except when refreshing), is fast in speed, and generally serves as a temporary data storage medium for operating a system or other running programs. RAM may write (store) or read (retrieve) information from any specified address at any time during operation. The main difference between the RAM and an ROM is the volatility of the data, that is, once the power is cut off, the stored data will be lost. The RAM is configured to temporarily store programs, data, and intermediate results in the computer and digital system.

### Embodiment 1

An embodiment of the present disclosure further provides a method embodiment of a quantum operation processing method. It is to be noted that the steps shown in the flow diagram of the accompanying drawings may be executed in a computer system, such as a set of computer-executable instructions, and although a logical sequence is shown in the flow diagram, in some cases, the steps shown or described may be executed in a different order than here.

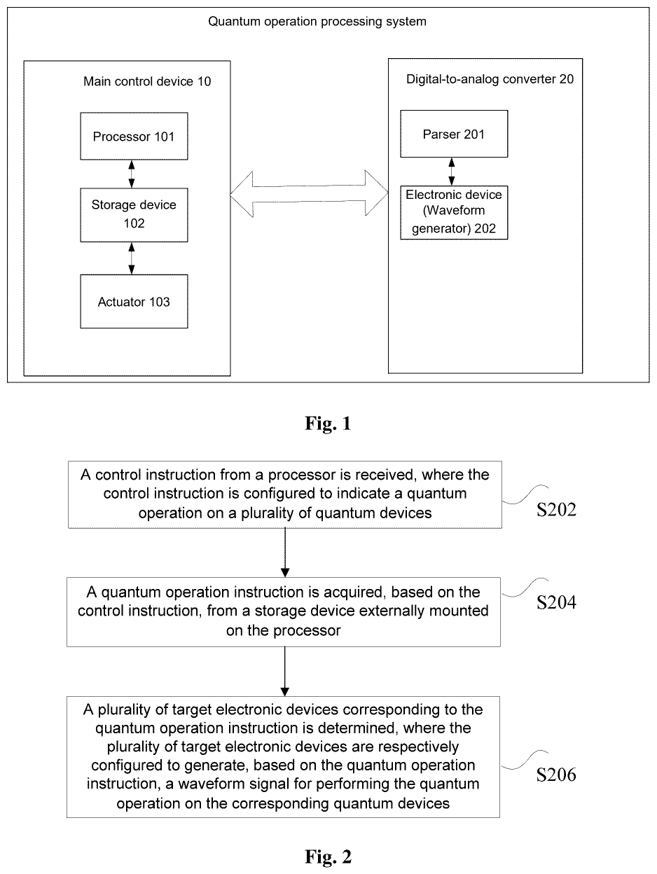

The method embodiment provided in Embodiment 1 of the present disclosure may be implemented in a quantum operation processing system. FIG. 1 is a block diagram of a hardware structure of a quantum operation processing system according to embodiments of the present disclosure. As shown in FIG. 1, the quantum operation processing system includes: a main control device 10 and a digital-to-analog converter 20, where the main control device 10 includes a processor 101, a storage device 102, and an actuator 103; the digital-to-analog converter 20 includes a parser 201 and an electronic device 202; the processor 101 is configured to generate a control instruction, and the control instruction is configured to indicate a quantum operation on a plurality of quantum devices; the storage device 102 is configured to store a quantum operation instruction; the actuator 103 is configured to acquire, based on the control instruction, a quantum operation instruction from a storage device externally mounted on the processor; the parser 201 is configured to determine the plurality of target electronic devices corresponding to the quantum operation instruction; and the electronic device 202 is configured to generate, based on the quantum operation instruction, a waveform signal for performing the quantum operation on the corresponding quantum devices.

Through the above structure, the control instruction of the processor can perform the quantum operations on the plurality of quantum devices at one time. With respect to the related art, a single quantum operation instruction is required for the quantum operation of one quantum device. For the single control instruction, the plurality of quantum devices can be operated by one control instruction, such that the processing efficiency of the quantum operation is effectively improved, the high efficiency of the instruction is achieved, and the technical problem in the related art of increased control complexity caused by a realized control amount increased accordingly when the number of electronic devices that need to be controlled is increased is solved.

As an optional embodiment, the main control device 10 may be connected to the digital-to-analog converter 20 through various connection manners. For example, the main control device 10 may be connected to the digital-to-analog converter 20 through a star connector, so as to transmit the quantum operation instruction acquired by the actuator 103 to the parser 201. The connection manner of the star connector can not only realize the centralization of various connection types, but also realize flexible configuration between various connections.

As an optional embodiment, the system further includes an analog-to-digital converter 30, where the analog-to-digital converter 30 is configured to read a quantum state of a quantum chip to obtain a read result, and transmit the read result to the storage device 102. The analog-to-digital converter 30 is added on the basis of the system including the digital-to-analog converter 20. Since the digital-to-analog converter 20 can convert the control instruction issued by the processor into the control of the quantum chip, the analog-to-digital converter 30 can read the quantum state of the quantum chip and feed back the quantum state to the processor. Therefore, through the above structure, not only can it achieve control processing from the processor to the quantum chip, but it can also feed back the state of the quantum chip to the processor, realizing bidirectional interaction between the processor and the quantum chip.

As an optional embodiment, the processor 101 may be interacted with the storage device 102 through various manners. For example, the processor 101 may read data from the storage device 102 via a general interface or write the data to the storage device 102. In order to achieve the efficiency of read and write operations, the function of a memory may be implemented by the storage device 102 externally mounted on the processor 101 through a predetermined interface, that is, the read and write operations of the data are implemented by means of using the externally-mounted storage device 102 as the memory of the processor 101. For example, by means of an MMIO interface, the storage device 102 is mounted on a system bus of the processor 101 through the MMIO interface. Through the above processing, the storage device 102 externally mounted on the processor 101 may be equivalent to the memory of the processor 101. Therefore, when the processor 101 reads the data from the storage device 102, it is equivalent to reading the data from its own memory; and when the processor 101 writes the data to the storage device 102, it is equivalent to writing the data to its own memory. Through the above structure, the efficiency of the data reading and writing operations between the processor 101 and the storage device 102 can be achieved.

On the basis of the above hardware structure or an optional hardware structure, in view of the above problems mentioned in the present disclosure, the present disclosure provides a quantum operation processing method shown in FIG. 2. FIG. 2 is a flowchart of the quantum operation processing method according to Embodiment 1 of the present disclosure. As shown in FIG. 2, the flow includes the following steps.

At S202, a control instruction from a processor is received, where the control instruction is configured to indicate a quantum operation on a plurality of quantum devices.

As an optional embodiment, an execution subject of the method in this embodiment may be a hardware chip configured to implement quantum operation processing, or a software module, or a combination apparatus of the hardware chip and the software module. The above combination apparatus of the hardware chip and the software module may be a component on a hardware device, or may also be a plurality of components on different hardware devices. The portion implementing the above software module may be a local computer terminal, or may also be a remote computer terminal; may be a client device, or may also be a server. There may also be various types of servers. For example, the server may be a local server, or may also be a virtual cloud server. The server, according to computing power, may be a single computer device, or may also be a computer cluster in which a plurality of computer devices are integrated.

As an optional embodiment, there may be one or more control instructions described above, and one or the above one or more control instructions is configured to indicate the quantum operation on the plurality of quantum devices. A correspondence relationship between the control instruction and the quantum operation or the quantum device may be considered as a one-to-many relationship, that is, a control operation on the plurality of quantum operations is realized by one control instruction.

As an optional embodiment, the above quantum device may refer to a quantum element configured to implementing certain functions. There may be various types of devices, for example, the devices may be quantum bits, quantum gates, quantum controllers, quantum reading resonant cavities, quantum processors, etc.

As an optional embodiment, there may also be various types of quantum operations on the quantum device. For example, the quantum operation may be a quantum state control operation, a quantum logic operation, a quantum gate operation, a quantum measurement operation, a quantum initialization operation, etc.

As an optional embodiment, when being the quantum bit, the above quantum device may be a superconducting qubit. There may be various types of the superconducting qubits, for example, the superconducting qubit may be a Transmon quantum bit or a Fluxonium quantum bit, etc.

As an optional embodiment, when being configured to indicate the quantum operation on the plurality of quantum devices, the above control instruction may indicate the same quantum operation on the plurality of quantum devices, and the plurality of quantum devices may also be the quantum devices of the same type; and the above control instruction may also indicate different operation on the plurality of quantum devices, which are specifically related to the configuration of the control instruction.

At S204, a quantum operation instruction is acquired, based on the control instruction, from a storage device externally mounted on the processor.

As an optional embodiment, the quantum operation instruction acquired from the storage device may correspond to the plurality of quantum devices, for example, the quantum operation may be performed on the plurality of quantum devices based on the quantum operation instruction. For example, there may be one quantum operation instruction, the quantum operation instruction carries an identifier, and the identifier indicates an object of the quantum operation is the plurality of quantum devices, such that when the quantum operation instruction is analyzed subsequently, the quantum operation on the plurality of quantum devices is realized. Therefore, a correspondence relationship between the quantum operation instruction and the quantum device or the quantum operation may also be a one-to-many relationship, such that the quantum operation is performed on the plurality of quantum devices through one quantum operation instruction.

As an optional embodiment, there may be various manners of externally mounting the storage device to the processor, for example, the storage device may be mounted on a system bus of the processor through an MMIO interface. Through the above processing, when the processor needs to read the quantum operation instruction from the storage device or write the quantum operation instruction to the storage device, the externally-mounted storage device may serve as a memory of its own for operation, so as to achieve efficient read and write operations of the quantum operation instruction.

As an optional embodiment, before acquiring, based on the control instruction, the plurality of quantum operation instructions from the storage device externally mounted on the processor, the quantum operation instructions may be stored in the externally-mounted storage device in various manners. For example, the quantum operation instructions may be respectively stored, and for ease of searching, the stored quantum operation instructions may also be numbered. In order to further improve the management of the quantum operation instructions in the storage device, different types of the quantum operation instructions may be stored in different address partitions in the storage device. The storing of different types of the quantum operation instructions through the address partitions can achieve the efficient management of the quantum operation instructions, not only making a write process clear, but also facilitating subsequent efficient reading.

At S206, a plurality of target electronic devices corresponding to the quantum operation instruction is determined, where the plurality of target electronic devices are respectively configured to generate, based on the quantum operation instruction, a waveform signal for performing the quantum operation on the corresponding quantum devices.

As an optional embodiment, there may be various manners of determining the plurality of target electronic devices corresponding to the quantum operation instruction, for example, the following processing manners may be used. When the quantum operation instruction carries first group information, the quantum operation instruction is broadcast to a plurality of candidate electronic devices, where the first group information is configured to indicate an electronic device targeted by the quantum operation instruction; a matching result between the first group information carried by the quantum operation instruction and second group information for the plurality of candidate electronic devices is acquired; and the plurality of target electronic devices are determined based on the matching results corresponding to the plurality of candidate electronic devices. By using the above manner, the target electronic device is determined based on the matching result between the group information (which indicates the electronic device corresponding to the quantum device for performing the quantum operation) carried in the quantum operation instruction and the group information corresponding to the plurality of candidate electronic devices themselves. It is to be noted that, the above process of determining the target electronic device may be implemented based on an identification function of the electronic device itself, that is, the electronic device receives the broadcast quantum operation instruction, analyzes the group information carried, and compares the analyzed group information with the group information corresponding to itself, and when the comparison results are consistent, it is determined that the quantum operation instruction needs to be processed by the electronic device, that is, the signal processing of the quantum operation corresponding to the quantum operation instruction is directly performed by the electronic device. The quantum operation performed on the plurality of quantum devices is realized by means of carrying the group information in the quantum operation instruction, and the quantum operation on the plurality of quantum devices may be realized through one quantum operation instruction, that is, batch processing of the quantum operations, such that the simplicity of the quantum operation instruction is greatly improved.

It is to be noted that, the above first group information or second group information may be characterized by various manners, for example, may be represented by means of a mask. In the mask, the electronic device corresponding to the quantum devices that need to perform the quantum operations together is marked by using different identifiers. For example, a form of the mask set for the electronic device is hexadecimal encoding: 0000 0000 1010 0001, where the 1st, 6th, and 8th bits are 1, indicating that the device belongs to Groups 0, 5, and 7, that is, when the Groups 0, 5, and 7 are carried in the quantum operation instruction, the electronic device needs to participate in the performing of the corresponding quantum operation, that is, needs to provide the corresponding waveform signal for the corresponding quantum operation.

As an optional embodiment, after determining the plurality of target electronic devices corresponding to the quantum operation instruction, the method further includes: when the quantum operation instruction is a non-waveform operation instruction, a mapping relationship between the non-waveform operation instruction and a waveform operation instruction is acquired; and the non-waveform operation instruction is mapped into the waveform operation instruction based on the mapping relationship, where the waveform operation instruction is configured to generate the waveform signal. Through the processing, it effectively achieves that when a complex quantum program needs to be processed, the processor does not need to send a large number of complex quantum operation instructions, but instead, the electronic device receiving an advanced quantum operation instruction maps the advanced quantum operation instruction into the waveform operation instruction that can perform the quantum operation, thereby achieving the simplification and efficiency of the quantum operation instruction.

It is to be noted that, there are various non-waveform operation instructions, for example, the non-waveform operation instruction may be a gate operation instruction, or may be an application operation instruction of a specific application, or may also be other more-advanced quantum operation instruction. That the non-waveform operation instructions are the gate operation instruction and the application operation instruction is described below with examples.

As an optional embodiment, converting the non-waveform operation instruction into the waveform operation instruction based on the mapping relationship may be performed as follows: the mapping relationship is determined as a first relationship when the non-waveform operation instruction includes a first gate operation instruction, where the first relationship is a correspondence relationship between a gate operation instruction and the waveform operation instruction; and the first gate operation instruction is mapped into a first waveform operation instruction based on the first relationship. Through the above processing, when the above non-waveform operation instruction is the gate operation instruction, since the gate operation instruction is an instruction that is more advanced than the waveform operation instruction, the acquired first gate operation instruction may be directly mapped into the first waveform operation instruction based on the first relationship between the gate operation instruction and the waveform operation instruction. It is to be noted that, when mapping is performed between the gate operation instruction and the waveform operation instruction, the mapping may be one-to-one or one-to-many. For example, one gate operation instruction may be mapped into one waveform operation instruction, or the gate operation instruction may also be mapped into a plurality of waveform operation instructions, which may be determined according to functions of the operation.

As an optional embodiment, converting the non-waveform operation instruction into the waveform operation instruction based on the mapping relationship may also be performed as follows: the mapping relationship is determined as a first relationship and a second relationship when the non-waveform operation instruction includes an application operation instruction, where the first relationship is a correspondence relationship between a gate operation instruction and the waveform operation instruction, and the second relationship is a correspondence relationship between the application operation instruction and the gate operation instruction; the application operation instruction is mapped into a second gate operation instruction based on the second relationship; and the second door operation instruction is mapped into a second waveform operation instruction based on the first relationship.

Based on the above processing, when the non-waveform operation instruction includes the application operation instruction, since the application operation is an instruction that is more advanced than the gate operation instruction, and the gate operation instruction is the instruction that is more advanced than the waveform operation instruction, the mapping of the application operation instruction into the waveform operation instruction may be implemented by means of layer-by-layer mapping. For example, first, the acquired application operation instruction is mapped into the second gate operation instruction based on the second relationship between the application operation instruction and the gate operation instruction; and then, the second gate operation instruction is mapped into the second waveform operation instruction based on the first relationship between the gate operation instruction and the waveform operation instruction, such that the application operation instruction is mapped into the waveform operation instruction. Similarly, it is to be noted here that, since the mapping between the application operation instruction and the gate operation instruction may be one-to-one or one-to-many, the mapping between the gate operation instruction and the waveform operation instruction may also be one-to-one or one-to-many. Therefore, when the mapping from the application operation instruction to the gate operation instruction is one-to-many and the mapping between the gate operation instruction and the waveform operation instruction is also one-to-many, there are more waveform operations obtained through the mapping of the application operation instruction. Therefore, through the above mapping relationship, it can also be seen that, through the above method, extensive maintenance of the control instructions of the processor or the quantum operation instructions of the storage device can be effectively avoided, thereby effectively achieving the simplification and efficiency of the overall instructions.

As an optional embodiment, in view of the above mapping relationship, there may be complex relationships. In order to achieve the ordered mapping between different quantum operation instructions, the above mapping relationship may be managed orderly. For example, based on different contents in the mapping relationship, storage is performed using different storage spaces. For example, the time and specific operation contents of the quantum operations may be stored separately. For example, the mapping relationship may be determined based on at least two memories, where one of the at least two memories is configured to store a time for mapping the corresponding quantum operation, and the other one is configured to store an identifier for mapping the corresponding quantum operation. It is to be noted that, the above memory may be an RAM, that is, the above mapping relationship is stored by two RAMs. By means of separate storage, in an aspect, different information can be read respectively, and in another aspect, since the information is independent, storage is simple and convenient.

As an optional embodiment, when needed, the above mapping relationship may also be updated and modified. For example, a relationship update instruction may be received based on a host computer; and in response to the relationship update instruction, the mapping relationship is updated. It is to be noted that, there may be various method for updating the mapping relationship, for example, adding the mapping relationship, modifying the mapping relationship, and deleting the mapping relationship. The number of the mapping relationships may be updated, or the content of the mapping relationship may also be updated, for example, updating the time content corresponding to the mapping relationship, or quantum operation content, etc.

Through the above processing, the control instruction from the processor is received, where the control instruction is configured to indicate the quantum operation on the plurality of quantum devices; based on the control instruction, the quantum operation instruction is acquired from the storage device externally mounted on the processor; and the plurality of target electronic devices corresponding to the quantum operation instruction is determined, and the plurality of target electronic devices respectively generate, based on the quantum operation instruction, the waveform signal for performing the quantum operation on the corresponding quantum devices. The control instruction of the processor can perform the quantum operations on the plurality of quantum devices at one time. With respect to the related art, a single quantum operation instruction is required for the quantum operation of one quantum device. For the single control instruction, the plurality of quantum devices can be operated by one control instruction, such that the processing efficiency of the quantum operation is effectively improved, the high efficiency of the instruction is achieved, and the technical problem in the related art of increased control complexity caused by a realized control amount increased accordingly when the number of electronic devices that need to be controlled is increased is solved.

Based on the above embodiments and optional embodiments, an optional implementation is provided.

In view of the problem in the related art that, when the number of electronic devices that need to be controlled is increased, a realized control amount is increased accordingly, resulting in increased control complexity, some possible implementation solutions attempt to use subcircuit-level parallel solutions. For example, a quantum circuit is divided into a plurality of subcircuits, and a compiler generates a corresponding instruction for each subcircuit. For the subcircuits that may be paralleled, the instructions corresponding to the plurality of subcircuits are performed in parallel by a plurality of processing units. However, the number of the instructions is not significantly reduced by using the method, and a multi-core processor is used for parallel execution, resulting in higher complexity. Another attempt method is to a 32-bit instruction set of a seven-bit superconducting quantum processor facing toward a two-dimensional square lattice connection structure. A quantum gate is flexible in operation, and allows for redefinition of a group of gates during compiling. However, the quantum gate is not easy to apply to a system with more quantum bits.

In order to solve the above problem, in this optional implementation, a modular quantum operation instruction processing solution is provided.

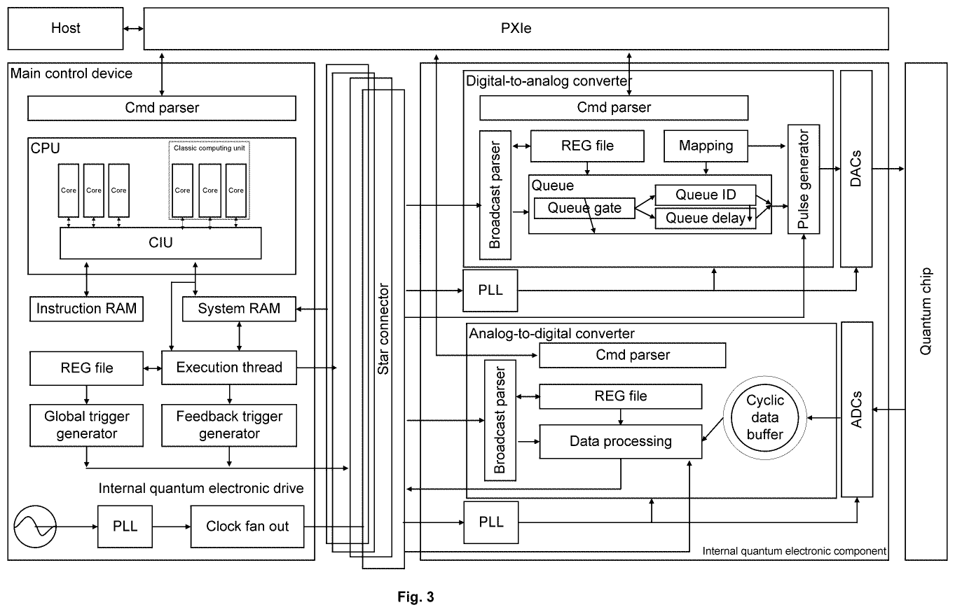

FIG. 3 is a system architecture diagram of a quantum operation processing system according to optional implementations of the present disclosure. As shown in FIG. 3, the system includes a host, a main control device, a digital-to-analog converter, an analog-to-digital converter, and a quantum chip. The main control device communicates with the digital-to-analog converter and the analog-to-digital converter through a star connector. As a host computer, the host correspondingly configures, modifies, etc., the main control device, the digital-to-analog converter, and the analog-to-digital converter through human-computer interaction. The main control device includes a command parsing unit, a CPU (which may include core groups for respectively processing various types of services), an RAM, a process actuator, etc. The main control device is configured to obtain the corresponding control instruction based on a received command and based on the CPU and the RAM. The control instruction may be a quantum control instruction, may be a classic control instruction, or may also include the quantum control instruction and the classic control instruction. The digital-to-analog converter is configured to convert, based on an instruction transmitted by the main control device, an instruction into a basic waveform operation instruction that is able to be performed by physical hardware, so as to generate the corresponding waveform signal through the waveform operation instruction, thereby performing the quantum operation on the quantum chip. The analog-to-digital converter is configured to receive the instruction from the main control device, measure the quantum state of the quantum chip to obtain a measurement result, feed back the measurement result to the main control device, and store the measurement result through the RAM on the main control device.

In this optional implementation, based on the above quantum operation processing system, in the quantum operation processing solution, all the quantum operation instructions are simplified into sw/lw operations of the CPU on an external memory, and the modular quantum operation instructions are configured to indicate different types of quantum operations. For example, different types of quantum operation instructions may include the waveform operation instruction, the gate operation instruction, and the application operation instruction. The waveform operation instruction, the gate operation instruction, and the operation instruction for a specific application based on the plurality of quantum bits may be distinguished through different address spaces, and an interface is an MMIO.

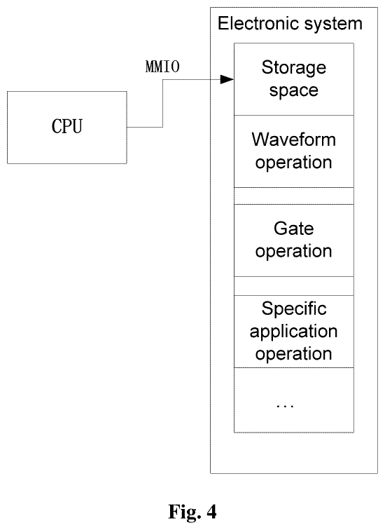

FIG. 4 is a schematic diagram of a connecting structure between a processor and a storage device in a quantum operation instruction processing method according to optional implementations of the present disclosure. As shown in FIG. 4, the processor (CPU) is connected to the storage device through the interface MMIO. The quantum operation refers to an operation that is performed on the quantum bit through a microwave signal, including a single-bit gate, a two-bit gate, etc. In this optional implementation, the electronic device (system) generating the microwave signal is used as an external device and mounted on a system bus of the CPU, with an interface being an MMIO. The CPU performs the sw/lw operation on the system bus through the MMIO, such that all the quantum operations may be implemented. Different quantum operation instructions are distinguished through addresses.

Based on the above structure, when a new quantum operation instruction is expanded, an unallocated address space in a memory space connected to the MMIO may be assigned as a mapping region of the new instruction, and a module for analyzing the new instruction is correspondingly added for these newly-added address spaces in the electronic device.

When the control instruction of the CPU is received, for example, the control instruction is configured to indicate a certain quantum operation on the plurality of quantum devices, the corresponding quantum operation instruction is read from the storage device through the above lw operation; then, preliminary analysis is performed on the quantum operation instruction to obtain a preliminary analysis result; and the preliminary analysis result is sent to the electronic device, and then the electronic device subsequently analyzes the above preliminary analysis result.

When the above preliminary analysis result is analyzed again, for some quantum operation instructions with high complexity (or some advanced quantum operation instructions), some mapping operations may be performed on the quantum operation instructions with high complexity to map same into simplified quantum operation instructions. Therefore, some mapping relationships between different quantum operation instructions may be added in the electronic device. For example, for the waveform operation instruction, the gate operation instruction, and the application operation instruction, the mapping of the gate operation instruction-the waveform operation instruction or the operation instruction for the specific application (i.e., the application operation instruction referred to above)-the gate operation instruction may be added. When a complex quantum program is run, the CPU sends the operation instruction for the specific application, and an integral waveform operation is analyzed by the electronic device.

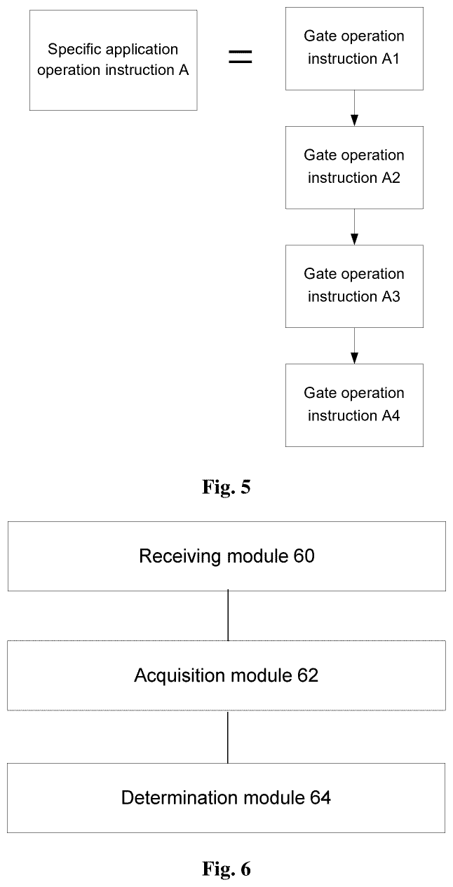

FIG. 5 is a schematic diagram of a mapping relationship between quantum operation instructions according to optional implementations of the present disclosure. As shown in FIG. 5, the mapping between the quantum operation instructions may be realized based on the mapping relationship. For example, in the figure, the operation instruction A for the specific application may indicate that the gate operation instruction A1 is performed at a moment a1, the gate operation instruction A2 is performed at a moment a2, and the gate operation instruction A3 is performed at a moment a3. It is to be noted that, the above mapping relationship may be modified through the host computer. For example, the existing mapping relationship is that the operation instruction A for the specific application may indicate that the gate operation instruction A1 is performed at the moment a1, the gate operation instruction A2 is performed at the moment a2, and the gate operation instruction A3 is performed at the moment a3; and then, the mapping relationship is modified, and the operation instruction A for the specific application may be modified as follows: the gate operation instruction A1 is performed at the moment a1, the gate operation instruction A3 is performed at the moment a2, and the gate operation instruction A2 is performed at the moment a3.

It is to be noted that, each mapping may be maintained by 2 RAMs. One stores time information a1, a2, a3, etc., and the other stores operation numbers A1, A2, A3, etc. The information stored by the RAM may also be modified by the host computer.

In order to achieve the function of performing the plurality of quantum operations through one quantum operation instruction, a mask configured to store group information (i.e., the group information referred to above) may be set in the electronic device. Some quantum bits are compiled into one group in advance, for example, group 5. The 6th bit of the mask of the group information in the electronic device corresponding to these quantum bits needs to be set to 1. For example, 16′h00a1 indicates that the electronic device belongs to group0, group5, and group7. When the plurality of quantum bits need to be operated at the same time to perform the same operation, the group may be operated. Specific implementation is as follows: the group information is compiled in an instruction, and then the instruction is broadcast to all electronic devices; and the electronic devices analyze the group information and operation information after receiving the instruction. The group information is compared with its own group mask, and the corresponding operation is performed when the group information is consistent with the group mask. Configuration of the group also supports modification by the host computer.

The following beneficial effects can be achieved through the above optional implementations.

A new instruction is easy to expand.

Modular design and the MMIO cause the expansion of the new instruction to perform the sw/lw operation on a new address. A new address space is assigned for the MMIO as a mapping region of the new instruction. An additional I/O of the CPU is not required, and an additional execution module corresponding to the new instruction is also not required. Therefore, the modular quantum instruction design is combined with the MMIO, such that a new quantum instruction may be conveniently designed in a quantum microinstruction architecture.

The efficiency of the instructions can be achieved.

In an aspect, the CPU may merely send a simple advanced quantum operation instruction. In the related art, a set of a plurality of basic waveform operations needs to be compiled for the complex quantum program, and the CPU is required to send more instructions. Through the mapping management among three operations (the waveform operation instruction, the gate operation instruction, and the application operation instruction), and by simply sending the advanced quantum operation instruction (e.g., the application operation instruction or the gate operation instruction), the set of the basic waveform operations is analyzed by the electronic device.

In another aspect, through the setting of the group and the broadcast instruction, any quantum bit may be conveniently configured as a group to perform the same complex quantum operation, and the number of the quantum instructions required has a significant advantage over traditional methods. In the related art, when the same operation is performed on the plurality of quantum bits, these electronic devices need to be controlled sequentially. In this optional implementation, through the design of the group mask and the broadcast instruction, the effect that one instruction controls the plurality of quantum bits at the same time may be achieved.

It is to be noted that, user information (including, but not limited to, user equipment information, user personal information, etc.) and data (including, but not limited to, data for analysis, stored data, displayed data, etc.) involved in the present disclosure all are information and data that is authorized by users or fully authorized by all parties. Furthermore, the collection, use, and processing of relevant data need to comply with relevant laws, regulations, and standards of the relevant countries and regions, and corresponding operation portals are provided for the users to choose to authorize or refuse.

It is to be noted that, for ease of simple description, the foregoing method embodiments are all expressed as a series of action combinations, but those skilled in the art should know that the present disclosure is not limited by the described action sequence, as according to the present disclosure, some steps may be performed in other sequences or simultaneously. Then, those skilled in the art should also know that the embodiments described in the specification are all preferred embodiments, and the actions and modules involved are not necessarily required by the present disclosure.

From the above descriptions about the implementation modes, those skilled in the art may clearly know that the method according to the foregoing embodiments may be implemented in a manner of combining software and a necessary universal hardware platform, and of course, may also be implemented through hardware, but the former is a preferred implementation mode under many circumstances. Based on such an understanding, the technical solutions of the present disclosure substantially or parts making contributions to the conventional art may be embodied in form of software product, and the computer software product is stored in a computer-readable storage medium (for example, a ROM/RAM), a magnetic disk and an optical disk), including a plurality of instructions configured to enable a terminal device (which may be a mobile phone, a computer, a server, a network device, or the like) to execute the method in each embodiment of the present disclosure.

### Embodiment 2

An embodiment of the present disclosure further provides an apparatus configured to implement the above quantum operation processing method. FIG. 6 is a structural block diagram of a quantum operation processing apparatus according to embodiments of the present disclosure. As shown in FIG. 6, the apparatus includes a receiving module 60, an acquisition module 62, and a determination module 64. The apparatus is described below.

The receiving module 60 is configured to receive a control instruction from a processor, where the control instruction is configured to indicate a quantum operation on a plurality of quantum devices; the acquisition module 62 is connected to the above receiving module 60, and is configured to acquire, based on the control instruction, a quantum operation instruction from a storage device externally mounted on the processor; and the determination module 64 is connected to the above acquisition module 62, and is configured to determine a plurality of target electronic devices corresponding to the quantum operation instruction, where the plurality of target electronic devices are respectively configured to generate, based on the quantum operation instruction, a waveform signal for performing the quantum operation on the corresponding quantum devices.

It is to be noted here that, the above receiving module 60, acquisition module 62, and determination module 64 corresponds to S202 to S204 in Embodiment 1. Examples and application scenarios implemented by the above modules and the corresponding steps are the same, but are not limited to the contents disclosed in Embodiment 1.

### Embodiment 3

An embodiment of the present disclosure may provide a computer terminal, and the computer terminal may be any computer terminal device in a computer terminal group. Optionally, in this embodiment, the above computer terminal may also be replaced by a terminal device such as a mobile terminal.

Optionally, in this embodiment, the above computer terminal may be located in at least one network device among a plurality of network devices of a computer network.

In this embodiment, the above computer terminal may run program codes for the following steps in the quantum operation processing method of an application program. The control instruction from the processor is received, where the control instruction is configured to indicate the quantum operation on the plurality of quantum devices; based on the control instruction, the quantum operation instruction is acquired from the storage device externally mounted on the processor; and the plurality of target electronic devices corresponding to the quantum operation instruction is determined, where the plurality of target electronic devices are respectively configured to generate, based on the quantum operation instruction, a waveform signal for performing the quantum operation on the corresponding quantum devices.

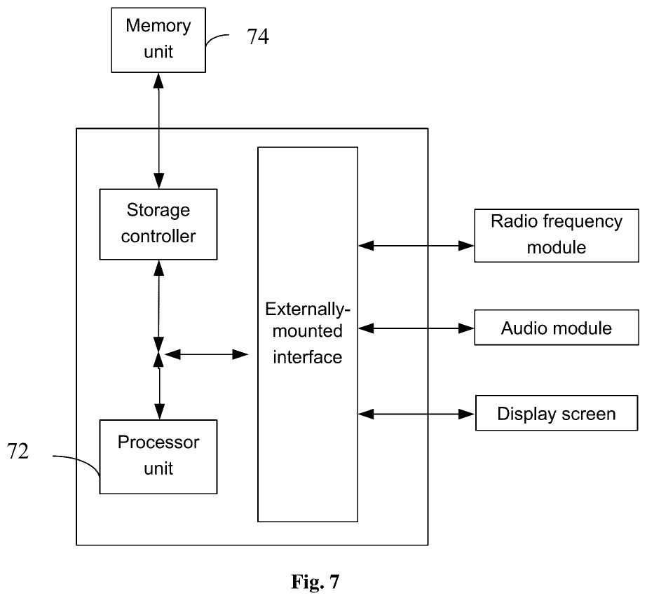

Optionally, FIG. 7 is a structural block diagram of a computer terminal according to embodiments of the present disclosure. As shown in FIG. 7, the computer terminal may include one or more processor units 72 (only one is shown in the figure), a memory unit 74, etc.

The memory unit may be configured to store software programs and modules, such as program instructions/modules corresponding to the quantum operation processing method and apparatus in the embodiments of the present disclosure. The processor unit performs various function applications and data processing by running the software programs and modules stored in the memory unit, that is, implementing the above quantum operation processing method. The memory unit may include a high-speed random access memory unit, and may further include a non-volatile memory unit, such as one or more magnetic disk memory apparatuses, a flash memory device, or other non-volatile solid-state memory units. In some examples, the memory unit may further include memory units remotely disposed relative to the processor unit. These remote memory units may be connected to the computer terminal via a network. Examples of the above NW include, but are not limited to, the Internet, an intranet, a local area NW, a mobile communication NW, and a combination thereof.

The processor unit may, through a transmission apparatus, call information and application programs stored by the memory unit, so as to perform the following steps: the control instruction from the processor is received, where the control instruction is configured to indicate the quantum operation on the plurality of quantum devices; based on the control instruction, the quantum operation instruction is acquired from the storage device externally mounted on the processor; and the plurality of target electronic devices corresponding to the quantum operation instruction is determined, where the plurality of target electronic devices are respectively configured to generate, based on the quantum operation instruction, the waveform signal for performing the quantum operation on the corresponding quantum devices.

The processor unit may also, through the transmission apparatus, call the information and application programs stored by the memory unit, so as to perform the following steps: before acquiring, based on the control instruction, the plurality of quantum operation instructions from the storage device externally mounted on the processor, the operation further includes: different types of the quantum operation instructions are stored in different address partitions in the storage device.

The processor unit may also, through the transmission apparatus, call the information and application programs stored by the memory unit, so as to perform the following steps: the storage device is mounted on a system bus of the processor through an MMIO interface.

The processor unit may also, through the transmission apparatus, call the information and application programs stored by the memory unit, so as to perform the following steps: determining the plurality of target electronic devices corresponding to the quantum operation instruction includes: when the quantum operation instruction carries first group information, the quantum operation instruction is broadcast to a plurality of candidate electronic devices, where the first group information is configured to indicate an electronic device targeted by the quantum operation instruction; a matching result between the first group information carried by the quantum operation instruction and second group information for the plurality of candidate electronic devices is acquired; and the plurality of target electronic devices are determined based on the matching results corresponding to the plurality of candidate electronic devices.

The processor unit may also, through the transmission apparatus, call the information and application programs stored by the memory unit, so as to perform the following steps: after determining the plurality of target electronic devices corresponding to the quantum operation instruction, the operation further includes: when the quantum operation instruction is a non-waveform operation instruction, a mapping relationship between the non-waveform operation instruction and a waveform operation instruction is acquired; and the non-waveform operation instruction is mapped into the waveform operation instruction based on the mapping relationship, where the waveform operation instruction is configured to generate the waveform signal.

The processor unit may also, through the transmission apparatus, call the information and application programs stored by the memory unit, so as to perform the following steps: converting the non-waveform operation instruction into the waveform operation instruction based on the mapping relationship includes: the mapping relationship is determined as a first relationship when the non-waveform operation instruction includes a first gate operation instruction, where the first relationship is a correspondence relationship between a gate operation instruction and the waveform operation instruction; and the first gate operation instruction is mapped into a first waveform operation instruction based on the first relationship.

The processor unit may also, through the transmission apparatus, call the information and application programs stored by the memory unit, so as to perform the following steps: converting the non-waveform operation instruction into the waveform operation instruction based on the mapping relationship includes: the mapping relationship is determined as a first relationship and a second relationship when the non-waveform operation instruction includes an application operation instruction, where the first relationship is a correspondence relationship between a gate operation instruction and the waveform operation instruction, and the second relationship is a correspondence relationship between the application operation instruction and the gate operation instruction; the application operation instruction is mapped into a second gate operation instruction based on the second relationship; and the second door operation instruction is mapped into a second waveform operation instruction based on the first relationship.

The processor unit may also, through the transmission apparatus, call the information and application programs stored by the memory unit, so as to perform the following steps: the mapping relationship is determined based on at least two memories, where one of the at least two memories is configured to store a time for mapping the corresponding quantum operation, and the other one is configured to store an identifier for mapping the corresponding quantum operation.

The processor unit may also, through the transmission apparatus, call the information and application programs stored by the memory unit, so as to perform the following steps: a relationship update instruction is received; and the mapping relationship is updated in response to the relationship update instruction.

The processor unit may also, through the transmission apparatus, call the information and application programs stored by the memory unit, so as to perform the following step: the quantum device is a quantum bit, and the quantum bit is a Fluxonium quantum bit.

Those of ordinary skill in the art may understand that, the structure shown in FIG. 7 is only schematic, the computer terminal may also be a smart phone (such as an Android phone, an iOS phone, or the like), a tablet computer, a handheld computer, a Mobile Internet Device (MID), PAD, and other terminal devices. FIG. 7 does not constitute a limitation on the structure of the foregoing electronic device. For example, the computer terminal 7 may further include more or less components (e.g., a network interface, a display apparatus, etc.) than those shown in FIG. 7, or have a different configuration from that shown in FIG. 7.

Those of ordinary skill in the art may understand that, all or part of the steps in the various methods of the above embodiments may be completed by instructing hardware related to the terminal device through a program. The program may be stored in a computer-readable storage medium, and the computer-readable storage medium may include a flash disk, a Read-Only Memory (ROM), a Random Access Memory (RAM), a magnetic disk, or an optical disk.

### Embodiment 4

An embodiment of the present disclosure further provides a computer-readable storage medium. Optionally, in this embodiment, the computer-readable storage medium may be configured to save program codes executed by the quantum operation processing method provided in Embodiment 1.

Optionally, in this embodiment, the computer-readable storage medium may be located in any computer terminal in a computer terminal group in a computer network, or located in any mobile terminal in a mobile terminal group.

Optionally, in this embodiment, the computer-readable storage medium is further configured to store program codes for performing the following steps: the control instruction from the processor is received, where the control instruction is configured to indicate the quantum operation on the plurality of quantum devices; based on the control instruction, the quantum operation instruction is acquired from the storage device externally mounted on the processor; and the plurality of target electronic devices corresponding to the quantum operation instruction is determined, where the plurality of target electronic devices are respectively configured to generate, based on the quantum operation instruction, a waveform signal for performing the quantum operation on the corresponding quantum devices.

Optionally, in this embodiment, the computer-readable storage medium is further configured to store program codes for performing the following steps: before acquiring, based on the control instruction, the plurality of quantum operation instructions from the storage device externally mounted on the processor, the operation further includes: different types of the quantum operation instructions are stored in different address partitions in the storage device.

Optionally, in this embodiment, the computer-readable storage medium is further configured to store program codes for performing the following step: the storage device is mounted on a system bus of the processor through an MMIO interface.

Optionally, in this embodiment, the computer-readable storage medium is further configured to store program codes for performing the following steps: determining the plurality of target electronic devices corresponding to the quantum operation instruction includes: when the quantum operation instruction carries first group information, the quantum operation instruction is broadcast to a plurality of candidate electronic devices, where the first group information is configured to indicate an electronic device targeted by the quantum operation instruction; a matching result between the first group information carried by the quantum operation instruction and second group information for the plurality of candidate electronic devices is acquired; and the plurality of target electronic devices are determined based on the matching results corresponding to the plurality of candidate electronic devices.

Optionally, in this embodiment, the computer-readable storage medium is further configured to store program codes for performing the following steps: after determining the plurality of target electronic devices corresponding to the quantum operation instruction, the operation further includes: when the quantum operation instruction is a non-waveform operation instruction, a mapping relationship between the non-waveform operation instruction and a waveform operation instruction is acquired; and the non-waveform operation instruction is mapped into the waveform operation instruction based on the mapping relationship, where the waveform operation instruction is configured to generate the waveform signal.

Optionally, in this embodiment, the computer-readable storage medium is further configured to store program codes for performing the following steps: converting the non-waveform operation instruction into the waveform operation instruction based on the mapping relationship includes: the mapping relationship is determined as a first relationship when the non-waveform operation instruction includes a first gate operation instruction, where the first relationship is a correspondence relationship between a gate operation instruction and the waveform operation instruction; and the first gate operation instruction is mapped into a first waveform operation instruction based on the first relationship.

Optionally, in this embodiment, the computer-readable storage medium is further configured to store program codes for performing the following steps: converting the non-waveform operation instruction into the waveform operation instruction based on the mapping relationship includes: the mapping relationship is determined as a first relationship and a second relationship when the non-waveform operation instruction includes an application operation instruction, where the first relationship is a correspondence relationship between a gate operation instruction and the waveform operation instruction, and the second relationship is a correspondence relationship between the application operation instruction and the gate operation instruction; the application operation instruction is mapped into a second gate operation instruction based on the second relationship; and the second door operation instruction is mapped into a second waveform operation instruction based on the first relationship.

Optionally, in this embodiment, the computer-readable storage medium is further configured to store program codes for performing the following step: the mapping relationship is determined based on at least two memories, where one of the at least two memories is configured to store a time for mapping the corresponding quantum operation, and the other one is configured to store an identifier for mapping the corresponding quantum operation.

Optionally, in this embodiment, the computer-readable storage medium is further configured to store program codes for performing the following steps: a relationship update instruction is received; and the mapping relationship is updated in response to the relationship update instruction.

Optionally, in this embodiment, the computer-readable storage medium is further configured to store program codes for performing the following step: the quantum device is a quantum bit, and the quantum bit is a Fluxonium quantum bit.

The serial numbers of the foregoing embodiments of the present disclosure are merely for description, and do not represent the superiority or inferiority of the embodiments.

In the above embodiments of the present disclosure, the description of the embodiments has its own focus. For parts that are not described in detail in a certain embodiment, reference may be made to related descriptions of other embodiments.

In the several embodiments provided in the present disclosure, it should be understood that, the disclosed technical content can be implemented in other ways. The apparatus embodiments described above are merely illustrative. For example, the division of units is only a logical function division, and there may be other divisions in actual implementation. For example, a plurality of units or components may be combined or integrated into another system, or some features can be ignored, or not implemented. In addition, the displayed or discussed mutual coupling or direct coupling or communication connection may be indirect coupling or communication connection through some interfaces, units or modules, and may be in electrical or other forms.

The units described as separate components may or may not be physically separated. The components displayed as units may or may not be physical units, that is, the components may be located in one place, or may be distributed on the plurality of network units. Part or all of the units may be selected according to actual requirements to achieve the purposes of the solutions of this embodiment.

In addition, the functional units in the various embodiments of the present disclosure may be integrated into one processing unit, or each unit may exist alone physically, or two or more than two units may be integrated into one unit. The above integrated unit can be implemented in the form of hardware, or can be implemented in the form of a software functional unit.

If the integrated unit is implemented in the form of the software functional unit and sold or used as an independent product, it can be stored in the computer readable storage medium. Based on this understanding, the technical solutions of the present disclosure essentially or the parts that contribute to the related art, or all or part of the technical solutions can be embodied in the form of a software product. The computer software product is stored in a computer-readable storage medium, including a plurality of instructions for causing a computer device (which may be a personal computer, a server, or a network device, and the like) to execute all or part of the steps of the above method described in the various embodiments of the present disclosure. The foregoing computer-readable storage medium includes a USB flash disk, an ROM, an RAM, and various media that can store program codes, such as a mobile hard disk, a magnetic disk, or an optical disk.

The above description is merely preferred implementations of the present disclosure, and it should be noted that those of ordinary skill in the art may also make several improvements and refinements without departing from the principle of the present disclosure, and it should be considered that these improvements and refinements shall all fall within the protection scope of the present disclosure.

What is claimed is:

1. A quantum operation processing method, comprising:
receiving a control instruction from a processor, wherein the control instruction is configured to indicate to perform a quantum operation on a plurality of quantum devices;
acquiring, based on the control instruction, a quantum operation instruction from a storage device externally mounted on the processor; and
determining a plurality of target electronic devices corresponding to the quantum operation instruction, wherein the plurality of target electronic devices are respectively configured to generate, based on the quantum operation instruction, a waveform signal for performing the quantum operation on the corresponding quantum devices.

2. The method as claimed in claim 1, wherein before acquiring, based on the control instruction, the plurality of quantum operation instructions from the storage device externally mounted on the processor, the method further comprises:
storing different types of quantum operation instructions in different address partitions in the storage device.

3. The method as claimed in claim 1, wherein the storage device is mounted on a system bus of the processor through a Memory Mapping Input/Output (MMIO) interface.

4. The method as claimed in claim 1, wherein determining the plurality of target electronic devices corresponding to the quantum operation instruction comprises:
when the quantum operation instruction carries first group information, broadcasting the quantum operation instruction to a plurality of candidate electronic devices, wherein the first group information is configured to indicate an electronic device targeted by the quantum operation instruction;
acquiring a matching result between the first group information carried by the quantum operation instruction and second group information of the plurality of candidate electronic devices; and
determining the plurality of target electronic devices based on the matching results corresponding to the plurality of candidate electronic devices.

5. The method as claimed in claim 1, wherein after determining the plurality of target electronic devices corresponding to the quantum operation instruction, the method further comprises:
when the quantum operation instruction is a non-waveform operation instruction, acquiring a mapping relationship between the non-waveform operation instruction and a waveform operation instruction; and
mapping the non-waveform operation instruction into the waveform operation instruction based on the mapping relationship, wherein the waveform operation instruction is configured to generate the waveform signal.

6. The method as claimed in claim 5, wherein converting the non-waveform operation instruction into the waveform operation instruction based on the mapping relationship comprises:
determining the mapping relationship as a first relationship when the non-waveform operation instruction comprises a first gate operation instruction, wherein the first relationship is a correspondence relationship between a gate operation instruction and the waveform operation instruction; and
mapping the first gate operation instruction into a first waveform operation instruction based on the first relationship.

7. The method as claimed in claim 5, wherein converting the non-waveform operation instruction into the waveform operation instruction based on the mapping relationship comprises:
determining the mapping relationship as a first relationship and a second relationship when the non-waveform operation instruction comprises an application operation instruction, wherein the first relationship is a correspondence relationship between a gate operation instruction and the waveform operation instruction, and the second relationship is a correspondence relationship between the application operation instruction and the gate operation instruction;
mapping the application operation instruction into a second gate operation instruction based on the second relationship; and
mapping the second gate operation instruction into a second waveform operation instruction based on the first relationship.

8. The method as claimed in claim 5, further comprising: determining the mapping relationship based on at least two memories, wherein one of the at least two memories is configured to store a time for mapping the corresponding quantum operation, and the other one is configured to store an identifier for mapping the corresponding quantum operation.

9. The method as claimed in claim 5, further comprising:
receiving a relationship update instruction; and
updating the mapping relationship in response to the relationship update instruction.

10. The method as claimed in claim 1, wherein the quantum device is a quantum bit, and the quantum bit is a Fluxonium quantum bit.

11. (canceled)

12. A quantum operation processing system, comprising: a main control device and a digital-to-analog converter, wherein the main control device comprises a processor, a storage device, and an actuator; the digital-to-analog converter comprises a parser and an electronic device;
the processor is configured to generate a control instruction, wherein the control instruction is configured to indicate a quantum operation on a plurality of quantum devices;
the storage device is configured to store a quantum operation instruction;
the actuator is configured to acquire, based on the control instruction, a quantum operation instruction from a storage device externally mounted on the processor;
the parser is configured to determine a plurality of target electronic devices corresponding to the quantum operation instruction; and
the electronic device is configured to generate, based on the quantum operation instruction, a waveform signal for performing the quantum operation on a corresponding quantum device.

13. The system as claimed in claim 12, wherein the main control device is connected to the digital-to-analog converter through a star connector, so as to transmit the quantum operation instruction acquired by the actuator to the parser.

14. The system as claimed in claim 12, further comprising: an analog-to-digital converter, wherein the analog-to-digital converter is configured to read a quantum state of a quantum chip to obtain a read result, and transmit the read result to the storage device.

15. The system as claimed in claim 12, wherein the storage device is mounted on a system bus of the processor through a Memory Mapping Input/Output (MMIO) interface.

16. The method as claimed in claim 2, wherein the quantum device is a quantum bit, and the quantum bit is a Fluxonium quantum bit.

17. The method as claimed in claim 3, wherein the quantum device is a quantum bit, and the quantum bit is a Fluxonium quantum bit.

18. The method as claimed in claim 4, wherein the quantum device is a quantum bit, and the quantum bit is a Fluxonium quantum bit.

19. The method as claimed in claim 5, wherein the quantum device is a quantum bit, and the quantum bit is a Fluxonium quantum bit.

20. The method as claimed in claim 6, wherein the quantum device is a quantum bit, and the quantum bit is a Fluxonium quantum bit.

21. The method as claimed in claim 7, wherein the quantum device is a quantum bit, and the quantum bit is a Fluxonium quantum bit.
